(19) United States
(12) Patent Application Publication
(10) Pub. No.: US 2024/0001498 A1
(43) Pub. Date: Jan. 4, 2024

(54) TOOL EXCHANGING ARM

(71) Applicant: FUJI CORPORATION, Chiryu (JP)

(72) Inventor: Kazuya ASAKAWA, Toyota-shi (JP)

(73) Assignee: FUJI CORPORATION, Chiryu (JP)

(21) Appl. No.: 18/315,527

(22) Filed: May 11, 2023

(30) Foreign Application Priority Data
Jul. 4, 2022 (JP) 2022-107627

(51) Int. Cl. B23Q 3/155; B23Q 3/157

(52) U.S. Cl. CPC B23Q 3/1554; B23Q 3/157; B23Q 2003/155418; B23Q 2003/155428

(57) ABSTRACT

A tool exchanging arm includes an arm main body, a fixed claw formed at both end portions of the arm main body, a movable claw pivotably supported on the arm main body, a first connecting member having a first end pivotally attached to a distal end portion of the movable claw, and a second connecting member having a first end pivotally attached to a second end of the first connecting member and a second end pivotally supported on the arm main body, in which an intermediate portion of the second connecting member comes into contact with an entering side portion of the tool and is pressed by rotation of the arm main body, and the movable claw pivots via the first connecting member pivotally attached to the second connecting member to grip the tool together with the fixed claw.

### TECHNICAL FIELD

The present invention relates to a tool exchanging arm configured to reduce impact generated by collision with a tool when the arm is rotated to grip the tool.

### BACKGROUND ART

Some machine tool has a configuration capable of replacing a tool of a tool main spindle device, and an automatic tool exchanging device for automatically exchanging a tool is provided in the machine tool. And some automatic tool exchanging device is configured to have a tool exchanging arm that grips a tool by tool chucks at both end portions and to exchange a tool by rotating the arm by, for example, 180°. Patent Literature 1 described below discloses a conventional tool exchanging arm. In the tool exchanging arm, tool chucks capable of opening and closing gripping claws are configured at both end portions, so that a tool to be exchanged can be gripped by each of the chucks.

As the tool chuck of the tool exchanging arm, a tool chuck in which a gripping claw (movable claw) is pivotably supported with respect to a fixed gripping claw (fixed claw) is configured. A cam follower is attached to an end of the movable claw, and is in contact with a pivotable pressing member urged by a compressed coil spring. An urging force of the compressed coil spring transmitted via the pressing member acts in a direction in which the movable claw opens in relation to the fixed claw. Therefore, during tool exchange, the tool exchanging arm rotates, a tool comes into contact with a gripping section in which the movable claw is opened, whereby the movable claw is closed to grip the tool.

### PATENT LITERATURE

Patent Literature 1: JP-A-H10-118870

### SUMMARY OF THE INVENTION

### Technical Problem

A tool exchanging arm grips a tool by rotating, and the tool relatively collides with a movable claw. At this time, a position at which the tool collides with the movable claw is distant from a position at which rotation of the tool exchanging arm is stopped, so that a collision occurred before a rotational speed drops. Therefore, impact received by the tool exchanging arm is also increased, so that an impact noise at that time is increased, and in addition, life is shortened by causing damage by repeated gripping operations. Although it is also conceivable to reduce the rotational speed in order to reduce the impact, since it is desirable to shorten time required for a tool exchange, the speed is maintained to a certain extent to make it difficult to resolve a problem.

Accordingly, it is an object of the present invention to provide a tool exchanging arm that reduces impact in a collision with a tool in order to solve such a problem.

### Solution to Problem

A tool exchanging arm according to the present invention includes an arm main body configured such that a gripping position of a tool is symmetrical about a central rotary shaft, a fixed claw formed at both end portions of the arm main body, a movable claw pivotably supported on the arm main body, a first connecting member having a first end pivotally attached to a distal end portion of the movable claw, and a second connecting member having a first end pivotally attached to a second end of the first connecting member and a second end pivotally supported on the arm main body, an intermediate portion of the second connecting member comes into contact with an entering side portion of the tool and is pressed by rotation of the arm main body, and the movable claw pivots via the first connecting member pivotally attached to the second connecting member to grip the tool together with the fixed claw.

### Advantageous Effect of the Invention

According to the configuration, although it is possible to grip a tool, by rotating an arm main body configured to be symmetrical about a central rotary shaft, with a gripping section including a fixed claw and a movable claw configured on both end portions thereof, at that time, an entering side portion of the tool that has relatively entered inside the gripping section comes into contact with an intermediate portion of a second connecting member, pivoting of the second connecting member with which the tool collides transmitted to a first connecting member and the movable claw to grip the tool. And, since the tool comes into contact with the second connecting member immediately before a stopping position of the rotating tool exchanging arm, it is possible to reduce impact.

### BRIEF DESCRIPTION OF DRAWINGS

FIG. 1 is a perspective view showing an example of a tool changer.

FIG. 2 is a plan view showing a tool exchanging arm.

FIG. 3 is a perspective view showing the tool exchanging arm.

FIG. 4 is an enlarged perspective view of a tool chuck during a closing operation shown in FIG. 3.

FIG. 5 is an N-N cross-sectional view of FIG. 2 showing a lock mechanism of the tool chuck.

FIG. 6 is a timing diagram of a cam device.

FIG. 7 is a diagram showing displacement in a closing operation of a movable claw.

### DESCRIPTION OF EMBODIMENTS

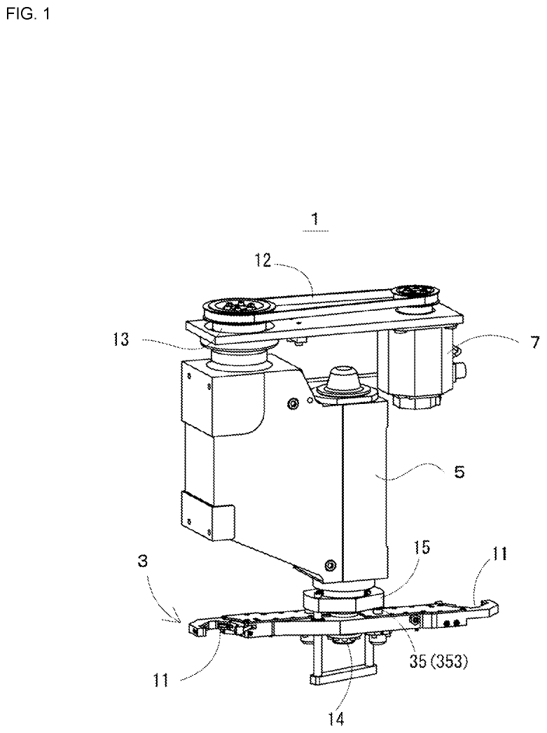

One embodiment of a tool exchanging arm according to the present invention will be described below with reference to the drawings. A tool exchanging arm of the present embodiment is incorporated in an automatic tool exchanging device that automatically exchanges a tool of a tool magazine in a machine tool, and particularly constitutes a tool changer that performs a direct tool exchange with respect to a tool main spindle device. FIG. 1 is a perspective view showing an example of the tool changer. In tool changer 1, transfer between a new tool conveyed from a tool magazine and a tool has been used in the tool main spindle device so far is performed.

Tool exchanging arm 3 in which a pair of tool chucks 11 capable of attachment/detachment of a tool is provided at both end portions is rotatably attached to tool changer 1, and tool changer 1 includes cam device 5 that rotates tool exchanging arm 3, servomotor 7 that outputs rotation to cam device 5, and the like. In cam device 5, input shaft 13 projects upward, and timing belt 12 is bridged between input shaft 13 and an output shaft of servomotor 7 via a pulley of each shaft.

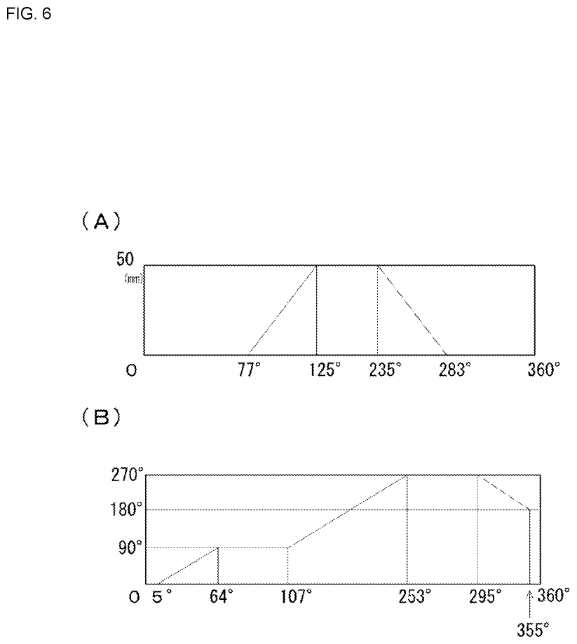

Cam device 5 is designed such that the rotation given to input shaft 13 is capable of outputting a predetermined motion from output shaft 14 projecting downward. That is, cam device 5 includes a grooved cam, a globoidal cam, or the like, so that output shaft 14 rotates and is also displaced in a vertical direction in accordance with the rotation of input shaft 13. Therefore, tool changer 1 is capable of adjusting a rotation angle and a position in the vertical direction of tool exchanging arm 3 by rotation control of servomotor 7. FIG. 6 is a timing diagram of cam device 5.

In the timing diagram, a horizontal axis represents a rotation angle of a cam, in FIG. 6(A), a vertical axis represents a movement position of tool exchanging arm 3 in the vertical direction, and in FIG. 6(B), a vertical axis represents the rotation angle of tool exchanging arm 3. Tool changer 1 of the present embodiment is configured such that attachment/detachment of a tool with respect to the tool main spindle device is performed at positions where the rotation angles are 90° and 270° in a case where a standby state of tool exchanging arm 3 is set to 0°. Rotation of tool exchanging arm 3 that changes as shown in FIG. 6(B) starts, for example, at a time point where the rotation angle of the cam gets to 5°, and reaches a rotational position of 90° at a time point where the rotation angle of the cam gets to 64°.

Then, posture of tool exchanging arm 3 is maintained at 90° until the rotation angle of the cam reaches 107°. Tool exchanging arm 3 that has taken out a tool from the tool main spindle device at rotation of 90°, in the next place, attaches a new tool to the tool main spindle device at a position of 270° which is rotated by 180°. Tool changer 1 displaces tool exchanging arm 3 in the vertical direction as shown in FIG. 6(A) at the rotational positions of 90° and 270°, so that detachment or attachment of a tool with respect to the tool main spindle device is performed.

Tool changer 1 according to the present embodiment stops at the rotational position of 90° in a step in which tool exchanging arm 3 goes to grasp a tool, but tool chuck 11 of tool exchanging arm 3 comes into contact with a tool immediately before a stopping position. Conventionally, an impact noise at this time is large, causing discomfort to an operator performing an operation in the factory. In addition, if large impact is received every time a tool is replaced, damage or the like to a component in tool exchanging arm 3 occurs, causing a tool to fall because of a failure of tool chuck 11.

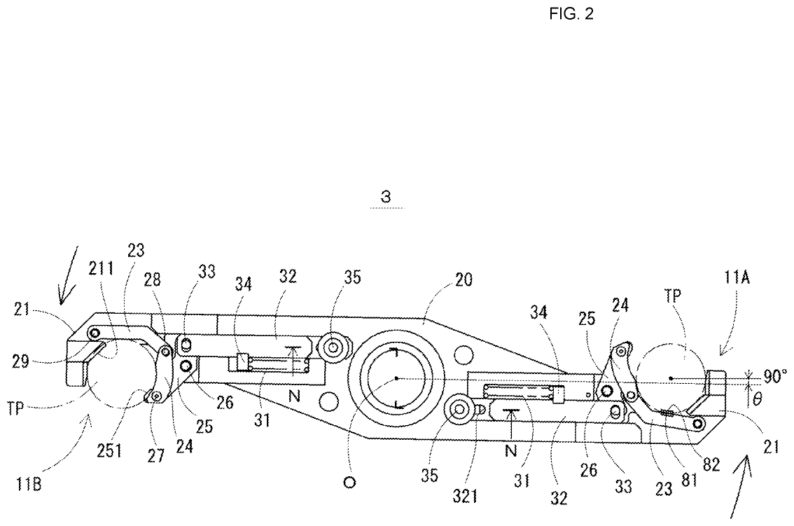

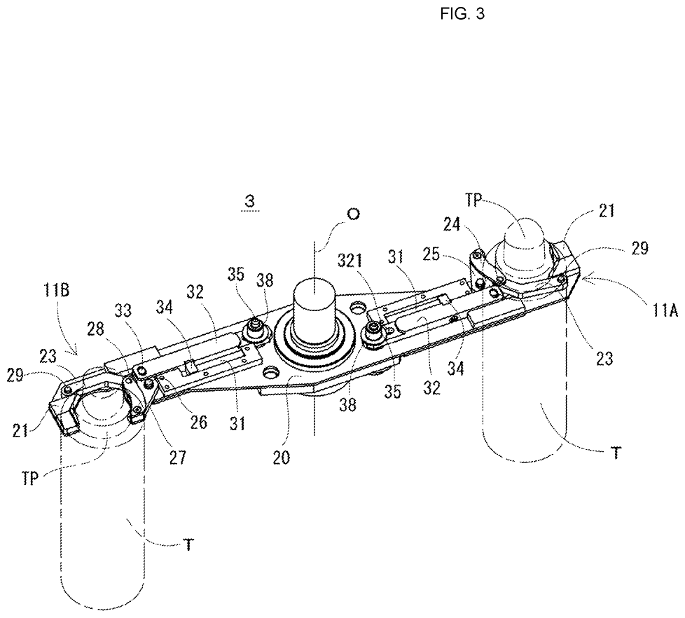

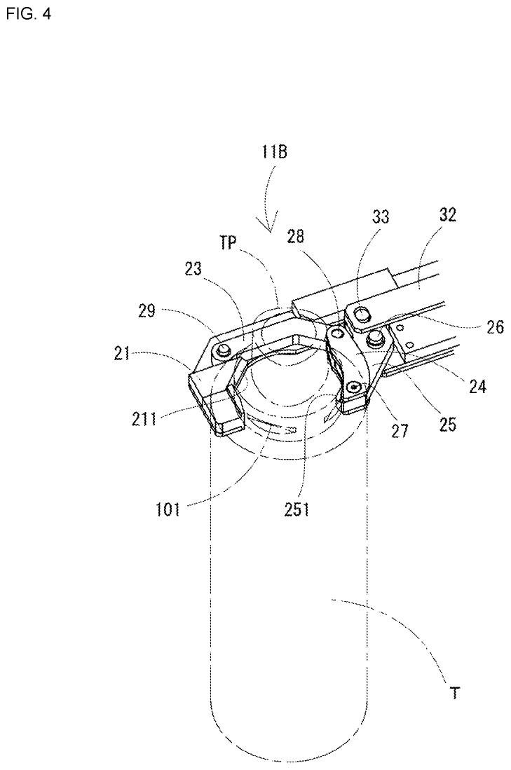

Accordingly, tool exchanging arm 3 of the present embodiment has a configuration for reducing the impact in a collision. FIGS. 2 and 3 are a plan view and a perspective view showing tool exchanging arm 3. In both drawings, a state in which tool chuck 11A among a pair of tool chucks 11 (11A, 11B) on a right side of the drawing does not grip tool T is shown, and a state in which tool chuck 11B among a pair of tool chucks 11 on a left side of the drawing grips tool T is shown. FIG. 4 is an enlarged perspective view of tool chuck 11B shown in FIG. 3.

In tool exchanging arm 3, tool chuck 11 is configured symmetrically with respect to diamond-shaped arm main body 20 at both end portions thereof. Both tool chucks 11 are configured to receive tool T from the same rotational direction (counterclockwise direction). Tool chuck 11 has fixed claw 21 integrally formed on each end portion of arm main body 20, and movable claw 25 is pivotably supported on a side of rotary shaft 0 of arm main body 20 with respect to fixed claw 21.

Incidentally, although tool T shown by chain lines in FIG. 3 is represented by a cylindrical shape, this only represents a contour area in which various tools stored in the tool magazine are housed. And tool holder TP is attached to a head section of actual tool T, and transfer is performed by gripping tool holder TP in the automatic tool exchanging device. Therefore, fixed claw 21 and movable claw 25 of tool chuck 11 are formed in a shape capable of grasping a gripped portion of tool holder TP having a substantially cylindrical shape.

Movable claw 25 is pivotally supported with respect to arm main body 20 by pin 26, and first connecting member 24 is pivotally attached via pin 27 to a distal end portion that grips tool holder TP. An end portion of connecting member 24 on a side opposite to a position of pin 27 is pivotally attached by pin 28 to closing operation lever 23 which is the second connecting member. Pin 28 is a pivot shaft of connecting member 24 that is displaced, and is formed on a side of connecting member 24 and is loosely fitted into a pin hole. An end portion of closing operation lever 23 on a side opposite to a position of pin 28 is pivotally supported on arm main body 20 by pin 29. Therefore, tool chuck 11 is a close-type link mechanism in which closing operation lever 23 pivotally supported on arm main body 20, connecting member 24, and movable claw 25 serve as links, so that each of pins 26, 27, 28, and 29 form a pivot pair.

As shown in FIG. 2, this link mechanism configured on tool chuck 11 is configured such that intermediate portion 81 of closing operation lever 23 comes into contact with entering side portion 82 of tool T (tool holder TP) that has relatively entered, is displaced by a reaction force received in a collision, and connecting member 24 and movable claw 25 pivot in accordance with a motion of closing operation lever 23. In the present embodiment, in a case where the rotational position described above at which tool exchanging arm 3 stops is set to 90°, closing operation lever 23 is designed to come into contact with tool holder TP at a position at which a remaining rotation angle θ is 1°. A displacement amount of closing operation lever 23 from the collision with tool T to the stoppage of tool exchanging arm 3 is about 4 mm.

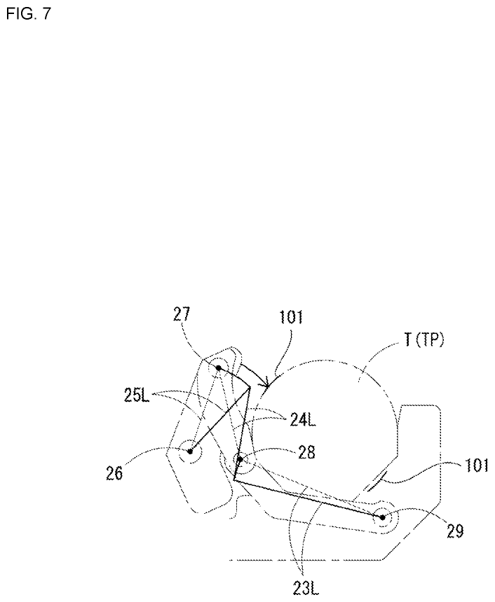

Incidentally, tool holder TP directly gripped by tool chuck 11 has fitting recessed portions 101 formed at four portions in a circumferential direction. Tool chuck 11 has fitting portion 211 formed in fixed claw 21 and fitting portion 251 formed in movable claw 25, and the fitting portions are fitted into two fitting recessed portions 101, so that tool holder TP can be securely gripped. As shown in FIG. 2, in a case where tool chuck 11 is viewed from a relative entering direction of tool T, fitting portion 211 of fixed claw 21 is fitted in an inner side thereof (a lower side in FIG. 7), and fitting portion 251 of movable claw 25 is fitted in a tool entrance side (an upper side in FIG. 7).

FIG. 7 is a diagram in which closing operation lever 23, connecting member 24, and movable claw 25 pivotally supported on arm main body 20 are replaced by rod-shaped links 23L, 24L, and 25L, and a motion thereof is illustrated. In the link mechanism of tool chuck 11, each of links 23L, 24L, and 25L is displaced from an open state position indicated by thin lines to a closed state position indicated by thick lines. That is, link 24L is pulled to the inner side of tool chuck 11 via pin 28 by pivoting of link 23L, whereby pin 27 on a side of a pivoting end of link 25L is caused to approach tool T, and further, link 25L pivots about pin 26, so that the pivoting end is caused to approach tool T.

Tool chuck 11 is placed in a closed state by the reaction force received by closing operation lever 23 from tool T, but at this time, it is necessary to allow tool T to enter a position of closing operation lever 23 without colliding with other members. Accordingly, spring 31 for urging movable claw 25 in an opening direction is provided so that tool chuck 11 in a normal time is opened to a certain extent. In arm main body 20 of tool exchanging arm 3, slide 32 that linearly moves in a longitudinal direction thereof is incorporated. Pin 33 fixed to movable claw 25 is loosely fitted into a long hole formed in one end portion of slide 32.

Pin 33 is located on an end portion of a side opposite to pin 27 with pin 26 serving as pivot shaft of movable claw 25 interposed therebetween. An urging force of spring 31 is transmitted to pin 33 via block 34 fixed to slide 32, so that movable claw 25 is constantly maintained in an open state by receiving a force in an outward direction of tool chuck 11, that is, a counterclockwise direction in FIG. 2. In addition, slide 32 has long hole 321 formed along a displacement direction in an end portion on a side of rotary shaft 0 opposite to the long hole for connecting into which pin 33 is inserted, and lock pin 35 is inserted into long hole 321.

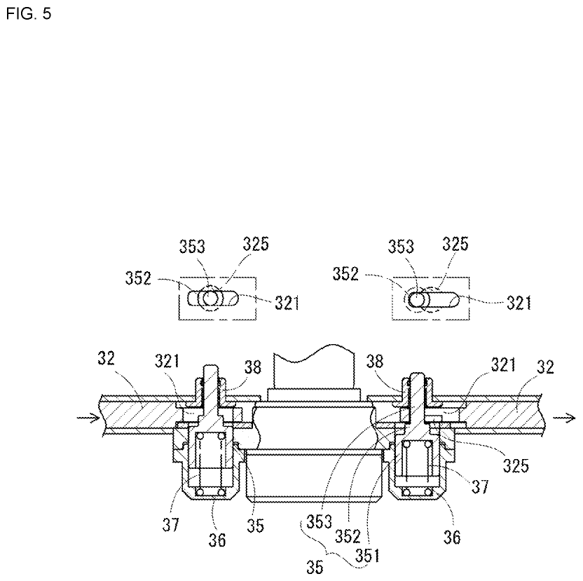

FIG. 5 is an N-N cross-sectional view of FIG. 2 showing the lock mechanism of tool chuck 11. The left and right lock mechanisms shown in the drawing have the same structure, an unlocked state corresponding to tool chuck 11A is illustrated on a right side of the drawing, and a locked state corresponding to tool chuck 11B is illustrated on a left side of the drawing. First, lock pin 35 is formed such that diameter dimension changes in three steps, and guide section 351 having a large diameter, lock section 352 at an intermediate position, and working section 353 having a small diameter are formed. Bowl-shaped guide cap 36 is fixed to a lower surface side of arm main body 20, and guide section 351 of lock pin 35 is slidably inserted into guide cap 36.

Locking spring 37 is inserted into a hole formed in guide section 351 from a bottom, and lock pin 35 is urged upward by being supported by guide cap 36. Working section 353 of lock pin 35 passes through long hole 321, and is inserted into guide tube 38 fixed to an upper surface side of arm main body 20, and a distal end portion of lock pin 35 protrudes. In long hole 321, locking recessed portion 325 in which a part of lock section 352 is inserted into a lower surface side is formed, so that the locked state is switched. A relationship between long hole 321 and lock pin 35 is shown in plan view at spots surrounded by chain lines in FIG. 5.

In long hole 321, locking recessed portion 325 having a widened width is formed in an arcuate shape at a center portion in a longitudinal direction thereof. In the normal time in which tool chuck 11 is in the open state, slide 32 is in a position urged in a direction away from rotary shaft 0 shown by an arrow as shown on the right side of the drawing, and lock section 352 is in contact with a lower surface of slide 32. Meanwhile, in a case where tool chuck 11 is switched to the closed state, slide 32 on the left side of the drawing moves in a direction approaching rotary shaft 0 shown by an arrow, so that lock section 352 relatively is inserted into locking recessed portion 325 of long hole 321. As a result, the movement of slide 32 is constrained, so that a closed state of movable claw 25 connected to slide 32 is maintained.

In order to release tool T gripped by tool chuck 11, it is necessary to press down lock pin 35 to remove lock section 352 from locking recessed portion 325. In this regard, a height of tool exchanging arm 3 changes in accordance with the rotation angle as shown in FIG. 6(A). Accordingly, tool exchanging arm 3 rises at a timing of releasing tool T, and working section 353 of lock pin 35 comes into contact with pressing ring 15 right above as shown in FIG. 1, so that lock pin 35 is relatively pressed down. In addition, pressing ring 15 is rotatably attached to output shaft 14 of cam device 5 by a radial bearing.

Next, action of tool changer 1 having tool exchanging arm 3 of the present embodiment will be described. By the rotation of 90° from the standby state, tool T of the tool main spindle device that has been used so far and new tool T that has been newly conveyed from the tool magazine are exchanged. Both tool chucks 11A and 11B of tool exchanging arm 3 in the standby state are in the open state, and are prepared to grip tool T. Accordingly, in a case of exchanging tool T, by drive control of servomotor 7, the rotation is converted via cam device 5, and is output as the rotation angle and the displacement in the vertical direction of tool exchanging arm 3.

Tool exchanging arm 3 that is rotated stops at the rotation angle of 90°, so that a gripping operation of tool T attached to the tool main spindle device is performed. That is, tool exchanging arm 3 starts the rotation from 0° and tool chuck 11 approaches tool T to be exchanged, but closing operation lever 23 collides with tool T at a rotational position of 89° immediately before the stopping position. Then, in remaining rotation of 1°, closing operation lever 23 is relatively pressed by tool T. At this time, since closing operation lever 23 is shaped so as to be bent like a dogleg toward a side of the tool that grips tool T, the collision with tool T entering tool chuck 11 can be made close to 90°.

Closing operation lever 23 pressed by the collision with tool T pivots about pin 29, so that connecting member 24 pivotally attached to pin 28 at a pivoting end is pulled. By displacing connecting member 24 in this manner, movable claw 25 pivots about pin 26, so that tool T is gripped by fixed claw 21 and movable claw 25. At this time, fitting portion 211 of fixed claw 21 and fitting portion 251 of movable claw 25 are fitted into fitting recessed portions 101 of tool holder TP in the position shown in FIG. 7, and tool T is gripped. In a case where movable claw is in the closed state, slide 32 is displaced by the pivoting of movable claw 25, so that the closed state of tool chuck 11 is maintained by lock pin 35. Thereafter, tool exchanging arm 3 is rotated by 180°, so that tools T gripped by tool chucks 11 at both ends are exchanged.

Therefore, according to tool exchanging arm 3 of the present embodiment, by configuring such that movable claw 25 pivots via connecting member 24 and closing operation lever 23, it is possible to grip tool T that collides at the position of 89° immediately before tool exchanging arm 3 stops at the rotation angle of 90°. Therefore, as a speed in a collision with tool T can be reduced in comparison with the conventional art, it is possible to reduce the impact noise that an operator feels to be uncomfortable. In addition, it is possible to mitigate the impact by coming into contact with tool T, so that the damage in tool exchanging arm 3 can also be prevented.

In the present embodiment, since a change of a rotational speed of tool exchanging arm 3 in a tool exchange is performed as it is in the conventional manner, it is unnecessary to modify a design of cam device 5 of tool changer 1, so that it is possible to obtain an effect of impact mitigation without increasing cost. In addition, in tool exchanging arm 3, since closing operation lever 23 is formed in a shape of a dogleg, it is possible to locate pin 28 on the tool entrance side of tool chuck 11. In addition, in tool exchanging arm 3, since connecting member 24 pivots while being pulled to the inner side of tool chuck 11, a pivoting angle of movable claw can be increased, so that it is possible for fitting portion 251 to be fitted into fitting recessed portion 101 of tool holder TP from the entrance side of tool chuck 11 to stabilize a gripping state.

Although one embodiment of the present invention has been described above, the present invention is not limited to this, and various modifications can be made without departing from the gist thereof.

For example, in the embodiment, although the stopping position of tool exchanging arm 3 is described as the rotation angle of 90°, the present invention is not limited to this, and although a position of collision with tool T that is set 1° before the stopping is described, the present invention is not limited to this either.

### REFERENCE SIGNS LIST

1 . . . tool changer, 3 . . . tool exchanging arm, 5 . . . cam device, 7 . . . servomotor, 11 (11A, 11B) . . . tool chuck, 20 . . . arm main body, 21 . . . fixed claw, 23 . . . closing operation lever, 24 . . . connecting member, 25 . . . movable claw, 26, 27, 28, 29 . . . pin, 31 . . . spring, 32 . . . slide, 35 . . . lock pin, T . . . tool, TP . . . tool holder

1. A tool exchanging arm comprising:
an arm main body configured such that a gripping position of a tool is symmetrical about a central rotary shaft;
a fixed claw formed at both end portions of the arm main body;
a movable claw pivotably supported on the arm main body;
a first connecting member having a first end pivotally attached to a distal end portion of the movable claw; and
a second connecting member having a first end pivotally attached to a second end of the first connecting member and a second end pivotally supported on the arm main body,
wherein an intermediate portion of the second connecting member comes into contact with an entering side portion of the tool and is pressed by rotation of the arm main body, and the movable claw pivots via the first connecting member pivotally attached to the second connecting member to grip the tool together with the fixed claw.

2. The tool exchanging arm according to claim 1, further comprising:
a spring member configured to urge the movable claw in a direction of an opening operation; and
a lock mechanism configured to maintain a closed state of the movable claw.

3. The tool exchanging arm according to claim 1,
wherein the second connecting member has a shape bent toward a side of the tool.

4. The tool exchanging arm according to claim 1, wherein a position at which the entering side portion of the tool comes into contact with the intermediate portion of the second connecting member by the rotation of the arm main body corresponds to a remaining rotation angle of 1° before a stopping position of the arm main body.

5. The tool exchanging arm according to claim 1, wherein, in the lock mechanism, a slide member is pivotally attached to a side opposite to the first connecting member with respect to the movable claw by a loosely fitted connecting pin, a positioning hole is formed in the slide member, and a lock pin urged by a locking spring is fitted into the positioning hole by a closing operation of the movable claw, thereby forming a locked state.
